(19) United States
(12) Patent Application Publication
(10) Pub. No.: US 2020/0001435 A1
(43) Pub. Date: Jan. 2, 2020

(54) CLAMPING MECHANISM

(71) Applicant: POWER BOX AG, Zug (CH)

(72) Inventor: Andrew Linton, York (GB)

(21) Appl. No.: 16/490,780

(22) PCT Filed: Mar. 6, 2018
(86) PCT No.: PCT/EP2018/055498

§ 371 Date: Sep. 3, 2019

(30) Foreign Application Priority Data
Mar. 7, 2017 (GB) 1703603.9

(51) Int. Cl. B25B 5/00; B25B 5/10; B25H 1/08

(52) U.S. Cl. CPC B25B 5/006; B25H 1/08; B25B 5/10

(57) ABSTRACT

The invention to which this application relates is a clamping apparatus (2, 52, 86) adapted to be used with a base (16) and to clamp (70) a workpiece (36, 38) in position with respect to a surface (38) of said base (16). The apparatus (2) includes an elongate shaft (60), at least one locating portion (10, 88) and engagement portion provided at or towards one end of the said shaft (60), a user operated actuation means selectively located between the said locating portion (10, 88) and the opposing end of the elongate shaft (60), said actuation means provided with, or connected to, a clamping portion and the base (16) includes one or more ports (18) or tracks with which the said locating portion (10, 88) and engagement portion is selectively located so as to selectively position the clamp (70) apparatus (2) with respect to the base (16).

The invention to which this application relates is a clamping apparatus of a type which is adapted to be used with a base on which a workpiece is to be placed to allow a work operation to be performed on the same using a power tool. In one embodiment the base can be provided as part of, for example, but not necessarily specifically, a workcentre of a type with which at least one type of power tool can be provided to be used.

The applicant, in their co-pending application EP 2872296, discloses a workcentre of one type which comprises a frame which is located on support legs. The frame defines an aperture into which a base can be fitted and retained. The base can be selected from a number of base types ranging from, for example, a base which, in conjunction with the frame upper surface, creates a worktable. The base may include, or be fitted with, a contractor saw power tool, a project saw power tool and/or other power tools. Alternatively the base may act as a router power tool mounting table or as a work surface and the bases are interchangeable with the frame to allow the user to select a particular function of the workcentre at that time. It should be appreciated that the apparatus described herein can be used with work centres or work tables other than that described above, or the base can be independent of or be provided as an integral part of a work table.

In the use of power tools such as circular saws, flooring saws, tile saws, routers, sanders and the like, the work which is performed by the power tool is performed on a workpiece, such as an item of wood or metal. Part of the requirement of the work operation is for the cut, routing or sanding to be performed in an accurate manner at the required location on the workpiece. In order to achieve this the conventional approach is either that the apparatus user applies a force onto the workpiece towards the surface of the base to try and hold the same in a fixed position and/or uses stops or a conventional screw clamp which can be attached to the edge of the base and clamps the workpiece located on its upper surface. The workpiece therefore has to be positioned so as to contact the one or more stops or clamps so to be at least partially held in position while the power tool is operated.

It is found that often when using the stops, while they may prevent the workpiece from moving in one direction, they do not prevent movement of the workpiece in other directions and/or the use of conventional clamping apparatus, whilst they can provide an improved gripping force on the workpiece, their use is limited by the fact that the clamp has to be mounted at the edge of the base in order to operate and therefore limits the positions at which the clamping effect can be applied to the workpiece. This means that the user of the apparatus often still has to exert a holding pressure on the workpiece using one of their hands. The requirement of the user to use their hand to contact the workpiece while attempting to operate the apparatus to perform the work on the workpiece is, at best, inconvenient, may often lead to the workpiece still moving and causing the work to be inaccurate and, at worst, places the user at risk of injury from the operating power tool.

An aim of the present invention is therefore to provide clamping apparatus which can be used in conjunction with a base to achieve a clamping effect to hold a workpiece in position with respect to the base and to allow the clamping effect to be achieved in an effective manner, thereby freeing up the user to operate the apparatus with both hands.

A further aim is to provide the clamping apparatus and base in a form such that, in combination, the range of locations with respect to the base at which the clamping apparatus can be used is increased, thereby allowing greater certainty that the workpiece can be effectively clamped in position regardless of the required location of the workpiece with respect to the surface of the base.

In a first aspect of the invention there is provided clamping apparatus for use in conjunction with a base to exert a clamping effect on a workpiece with respect to the base, said clamp apparatus including a body, one or more locating portions provided at one end of the body, a user operated actuation means which, when operated, moves a clamping portion to exert a force on the workpiece towards the base and clamp the workpiece with respect to the base and wherein said body is provided with a locating portion and an engaging portion to position the clamping apparatus with respect to a port or track of the said base.

In one embodiment when the clamping apparatus is engaged with the base, operation of the actuation means causes the clamping portion to be advanced towards the said base surface. Typically the actuation means is operated once the workpiece which is to be clamped is located between the base surface and the clamping portion and the said clamping portion is advanced until it contacts the workpiece and clamps the same in position on the said surface.

In one embodiment the actuation means is a member which is mounted on a threaded shaft on the body for rotation with respect to the same to cause movement of the clamping portion towards and away from the said locating portion of the body.

In one embodiment when the clamping apparatus is located for use with respect to the base, the longitudinal axis of the threaded shaft is substantially perpendicular to the said surface of the base on which the workpiece is located. In one embodiment when the apparatus is located for use with respect to the base, the direction of movement of the clamping portion when the actuation means is operated is substantially perpendicular to the surface of the base.

In one embodiment the locating portion is provided to be selectively positioned so as to provide a locating effect on the surface of the base opposing that on which the workpiece is to be located.

In one embodiment the locating portion is offset with respect to the axis of the clamping apparatus along which the clamping portion moves, and the engaging portion is provided along said axis such that when the locating portion is in location with the base, part of the locating portion engages with the base in at least one lateral direction.

In one embodiment the locating portion is provided of a form so as to be movable through the port in the base and once passed through the port to the side of the base opposing the side on which the workpiece is to be located, the locating portion is moved with respect to the base to allow the engaging portion to pass into and engage in the port with the locating portion contacting the underside of the base to at least one side of the port.

In one embodiment, the locating portion is received in or on a track which is located in or on the base and has engagement portions to engage with the track. Typically the track is linear in form and the locating portion can be selectively located along the track so as to allow the apparatus to be selectively located with respect to the base to provide a clamping effect at the desired position on the surface of the base.

In one embodiment the engagement portion comprises one or more lugs which protrude laterally from the locating portion to engage with channels in the track.

In one embodiment the base is provided with a plurality of said ports and/or tracks in a spaced configuration so that the clamping apparatus can be selectively located with any of said ports or tracks to provide the clamping apparatus at a suitable location for use.

In one embodiment the clamping apparatus is provided with biasing means to bias the locating portion into engagement with the base.

In a further aspect of the invention there is provided a clamping assembly, said assembly including clamping apparatus provided to exert a clamping effect on a workpiece with respect to a base, said clamping apparatus including an elongate shaft, at least one locating portion and an engagement portion provided at, or towards, one end of the said shaft, a user operated actuation means selectively located between the said locating portion and the opposing end of the elongate shaft, said actuation means provided with or connected to a clamping portion and wherein said base is provided with multiple ports or tracks with which the said locating portion and engagement means are selectively located by a user so as to selectively position the clamp apparatus with respect to the base.

In one embodiment the multiple ports or tracks are formed in a spaced configuration across the surface of the base on which the workpiece is to be clamped.

When said ports are provided the ports pass between said surface onto which the workpiece is clamped and the opposing surface of the base.

Specific embodiments of the invention are now described with reference to the accompanying drawings; wherein

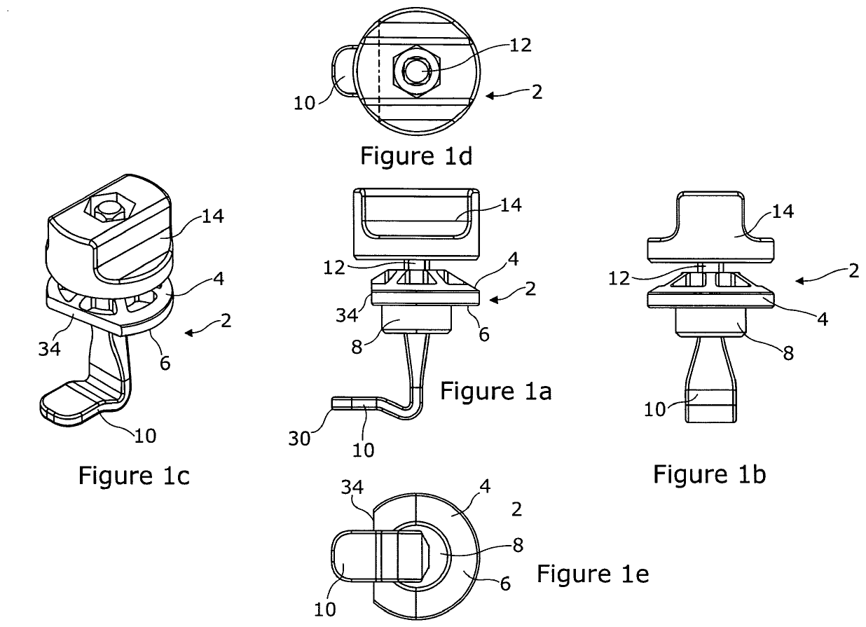

FIGS. 1a-e illustrate clamping apparatus in accordance with one embodiment of the invention;

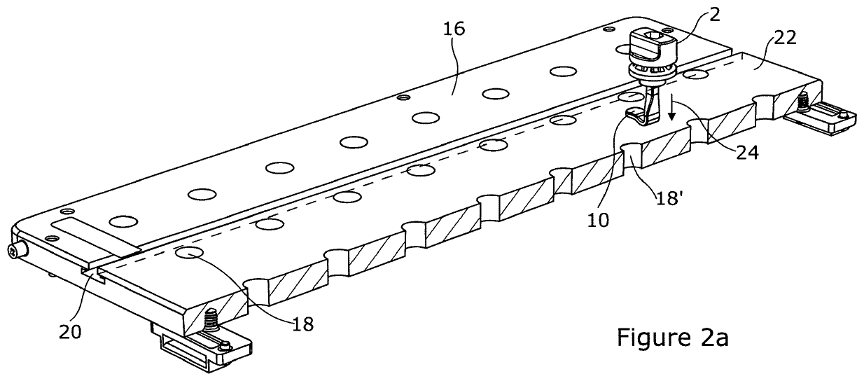

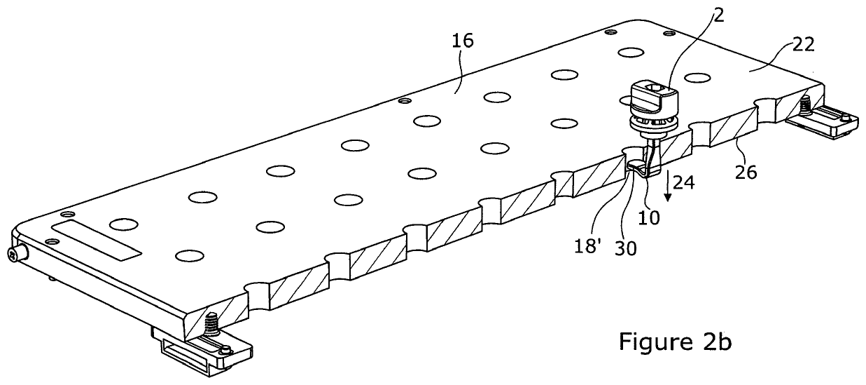

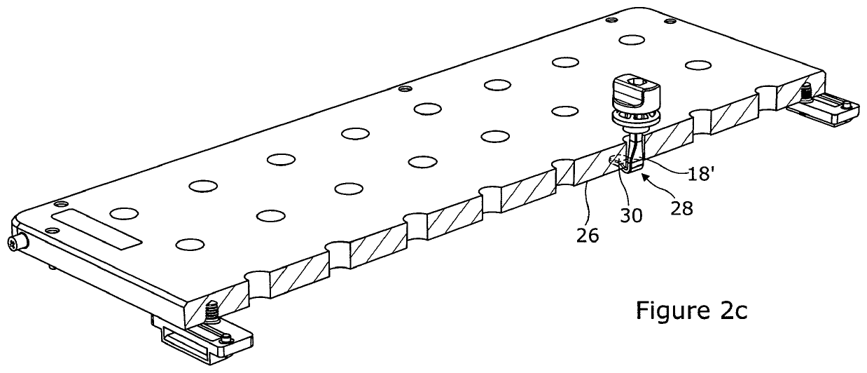

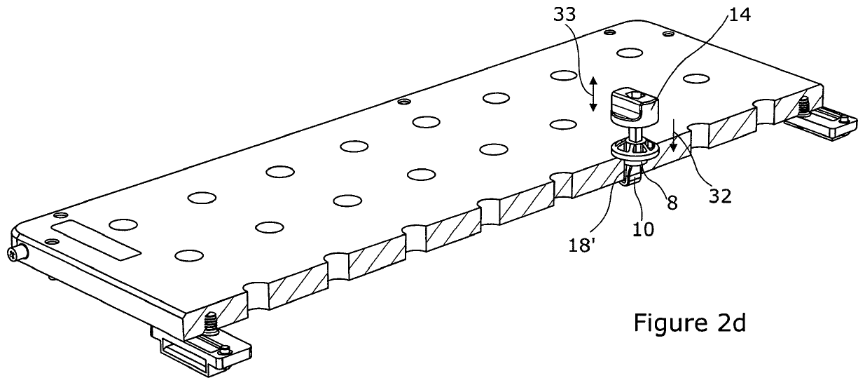

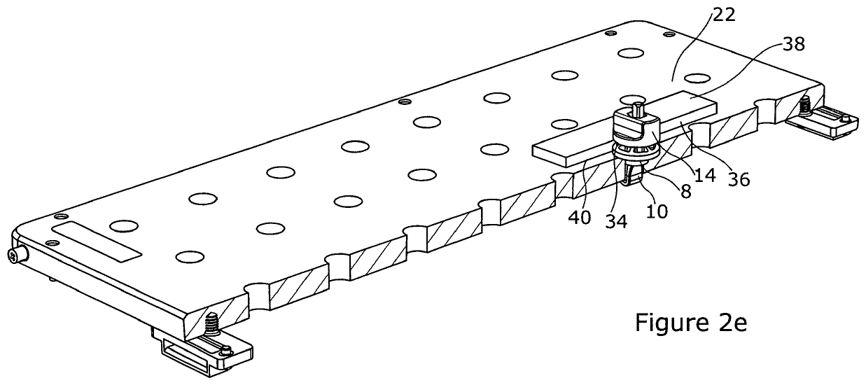

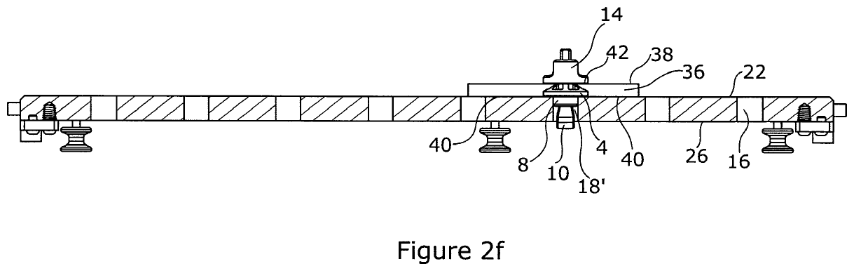

FIGS. 2a-f illustrate clamping apparatus in accordance with the first embodiment of the apparatus;

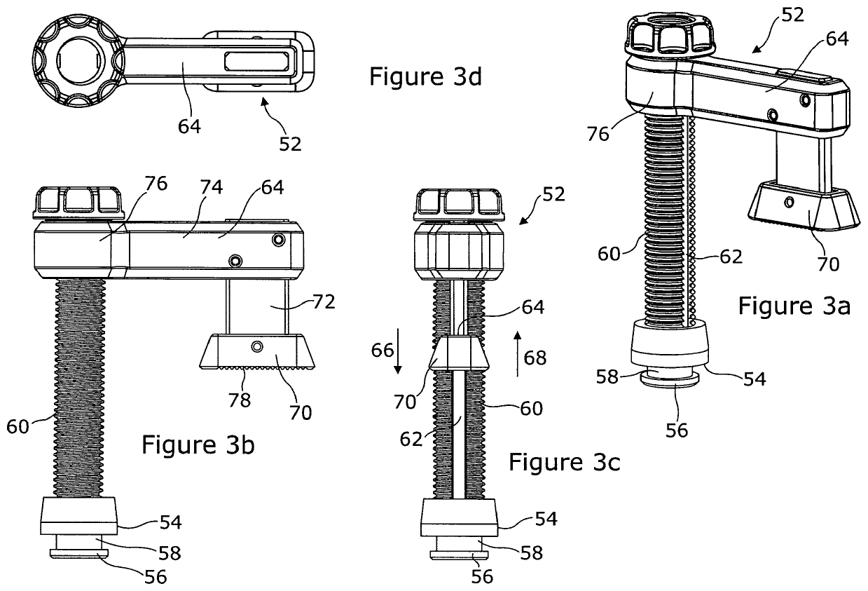

FIGS. 3a-d illustrate clamping apparatus in accordance with another embodiment of the invention in a first position;

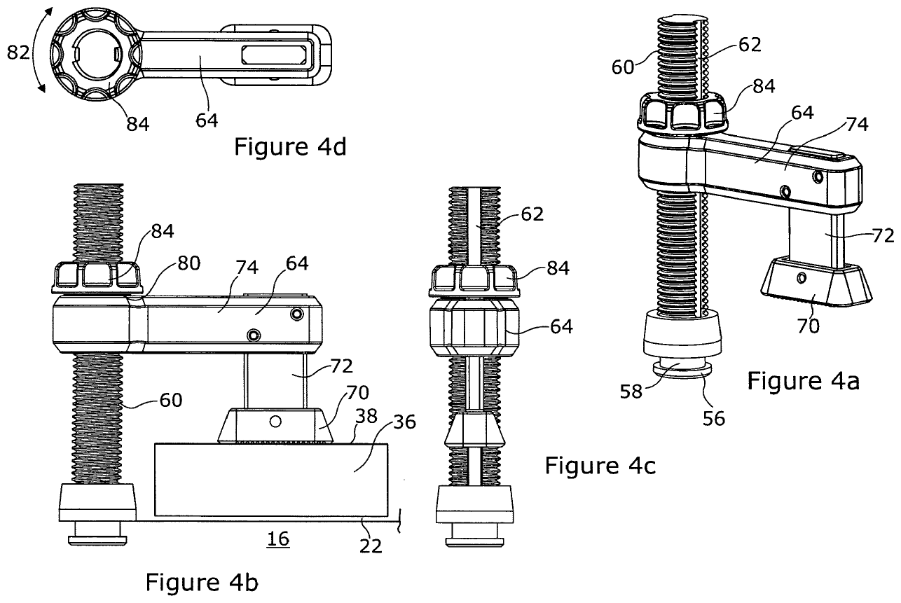

FIGS. 4a-d illustrate the clamping apparatus of FIGS. 3a-d having been moved to a lower position; and being moved into position using the clamp apparatus of FIGS. 2a-e; and

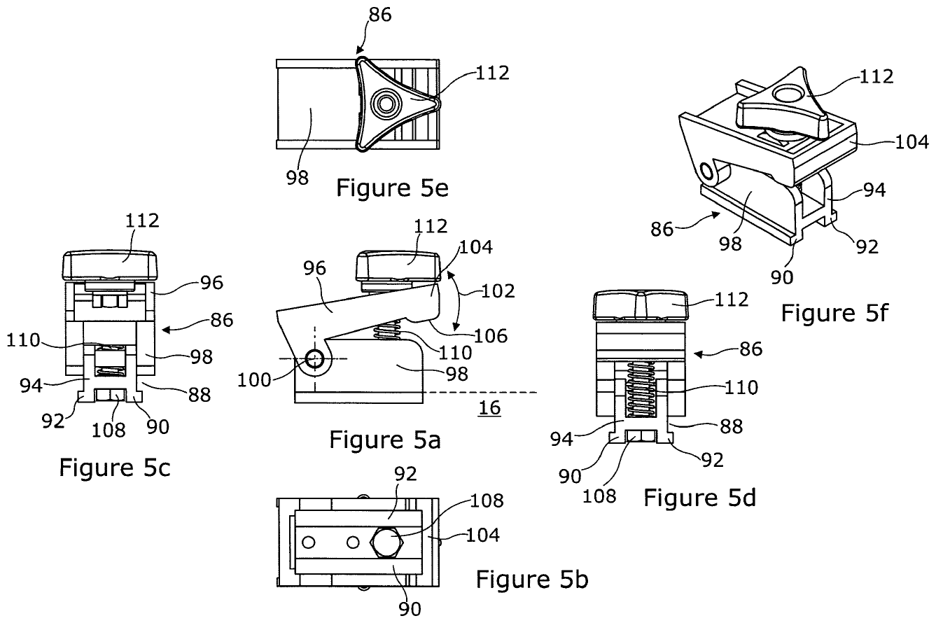

FIGS. 5a-f illustrate clamping apparatus in accordance with a further embodiment of the invention.

Referring firstly to FIGS. 1a-e, there is illustrated clamping apparatus in accordance with a first embodiment of the invention. The apparatus 2 includes a body 4 and from the underside 6 of the body there is provided an engaging portion 8 and a locating portion 10 depends from the engaging portion. At the topside of the body 4 there is provided a threaded shaft 12 with which is engaged actuating means 14.

The use of the clamping apparatus is illustrated with respect to FIGS. 2a-f.

As shown in FIG. 2a there is provided a base 16 with respect to which the clamping apparatus in accordance with the invention can be used. The base is shown in cross section so as to cut through a series of ports 18 formed in the base and for ease of illustrating the use of the clamping apparatus. In this embodiment the base includes a series of ports 18 and a track 20. This therefore allows the clamping apparatus to be selectively positioned at the desired one of a range of possible locations so as to provide for the most effective clamping to be achieved at a location which is desired with respect to the particular workpiece being clamped in position at that time. The track 20 is omitted from FIGS. 2b-f for clarity but its use will be explained subsequently.

The clamping apparatus 2 of this embodiment is provided to be used in conjunction with any selected one of the ports, in this illustration port 18′. As shown in FIG. 2a the locating portion 10 is initially provided on the top side 22 of the base 16 and so in order to move the apparatus into position, the locating portion 10 is of a size so that it can fit through the port 18 in the direction 24 as indicated in FIGS. 2a and b. Once the locating portion 10 has passed through the port 18 to be located under the underside 26 of the base 16 as shown in FIG. 2c, the same is moved laterally as indicated by arrow 28 so that the free end 30 lies to one side of the port 18′ and contacts with the underside 26 of the base 16. As shown in FIG. 2d the engaging portion 8 of the clamping apparatus is then moved downwardly as indicated by arrow 32 so as to locate in the port 18′ so that the clamping apparatus is not movable laterally with respect to the base and the free end 30 of the locating portion 10 prevents the clamping apparatus 2 from being raised out of the port 18′.

When the clamping apparatus us in this position the actuating means 14 can then be rotated to move the same up or down to the required height with respect to the base 16, as indicated by arrow 33 in FIG. 2d.

Typically, the body 4 of the clamping apparatus is provided with a substantially flat side portion 34 as illustrated in FIGS. 1a-e and this acts as the surface against which the side wall 36 of the workpiece 38 which is to be clamped, is positioned. The underside 40 of the workpiece is located on the top surface 22 of the base 16 as illustrated in FIGS. 2e and f. The underside 42 of the actuating means 14 which overhangs the flat side wall 34 of the body therefore provides the clamping force onto the workpiece top side 38 when the actuating means is tightened down onto the same and therefore clamps the workpiece in position with respect to the top surface 22 of the base 16.

Referring now to FIGS. 3a-d, 4a-d there is illustrated a further embodiment of clamping apparatus 52 with, in FIGS. 3a-d, the clamp 70 illustrated in a raised position, and in FIGS. 4a-d, the clamp 70 is shown in a lowered position and it should be appreciated that the clamp can be moved to selected positions intermediate those shown. The apparatus includes a location portion 54 which is provided with an engagement portion in the form of a skirt portion 56 and a neck portion 58 which are dimensioned so as to allow the same to be received in the track 20 in the base of the type shown in FIG. 2a. The clamping apparatus can be slid along the track to the required location so as to exert a clamping force onto a workpiece with respect to the base and the engagement of the location portion 54 with the track 20 ensures that the clamping apparatus is prevented from moving upwardly away from the base. The location portion is provided at one end of a threaded shaft 60 which has an elongate groove 62 with which a protrusion (not shown) provided on a clamping body 64 engages. The engagement of the protrusion and groove 62 assists in the guided movement of the clamping portion in the direction of arrows 66, 68 along the shaft 60.

The clamping body 64 includes a clamping plate 70 at its free end and this depends from an arm 72 which in turn is engaged to be perpendicular to arm 74 and, at the opposing end, the arm 74 engages with the threaded shaft via a port 76.

In order to move the arm into a clamping position so that the clamping plate 70 exerts a clamping force via teeth 78 on the surface 38 of a workpiece 36 as shown in FIG. 4b, the workpiece is moved into position between the base 16 and the clamping plate 70 and the body 64 is then slid down the threaded shaft 60 so that the clamping plate 70 is brought into contact with the surface 38 of the workpiece. When this is achieved the actuation means 84 is rotated as indicated by arrow 82 in the appropriate direction to move the same downwardly to contact the top face 80 of the clamping body 64 and therefore lock the clamping plate and hence workpiece 36 in position. When it is desired to release the clamping force, the actuation means 84 is rotated to move the same up the shaft and then the clamping body can be raised to release the workpiece.

In FIGS. 5a-f there is illustrated a further embodiment of clamping apparatus 86. The apparatus includes a body 98 with a location portion 88 which is provided with an engagement portion in the form of arms 90,92 and a neck portion 94 which are dimensioned so as to allow the same to be received in a track 20 in the base of the type shown in FIG. 2a. The clamping apparatus can be slid along the track to the required location so as to exert a clamping force onto a workpiece with respect to the base and the engagement of the locating portion 88 with the track 20 ensures that the clamping apparatus is prevented from moving upwardly away from the base. In this embodiment the apparatus is provided with a clamping arm 96 which is pivotally mounted on the body 98 at pivot axis 100 so as to selectively movable as indicated by arrow 102. The arm has a free end 104 which overlies and extends beyond the adjacent edge of the body 98 and this is where the free end can contact with the workpiece and exert a clamping force thereon with the workpiece (not shown) located between the base 16 and the bottom face 106 of the clamping arm 96.

In order to move the clamping arm 96 to the required position, there is provided actuation means in the form of a threaded shaft 110 which has a head 108 engaged with the body and which extends from the body through the clamping arm 96 to a locking knob 112. A spring 114 is located along the shaft to bias the clamping arm 96 to an upward position but rotation of the locking knob 112 in one direction acts against the spring to move the clamping arm 96 towards the body to exert a clamping force on the workpiece as required.

Thus there are provided clamping apparatus of a type which can be selectively used to advantage in exerting a clamping force on a workpiece with respect to a base and thereby free up the users hands to operate the power tool to perform the work more safely.

1. Clamping apparatus for use in conjunction with a base to exert a clamping effect on a workpiece with respect to the base, said clamp apparatus including a body, one or more locating portions provided at one end of the body, a user operated actuation means which, when operated, moves a clamping portion to exert a force on the workpiece towards the base and clamp the workpiece with respect to the base and wherein said body is provided with a locating portion and an engaging portion to position the clamping apparatus with respect to a port or track of the said base.

2. Apparatus according to claim 1 wherein when the apparatus is engaged with the base, operation of the actuation means causes a clamping portion to be advanced towards the said base.

3. Apparatus according to claim 2 wherein the actuation means is operated once the workpiece which is to be clamped is located between the base surface and the clamping portion so that the said clamping portion is advanced until it contacts the workpiece and clamps the same in position onto a surface of the said base.

4. Apparatus according to claim 1 wherein the actuation means is a member which is mounted on a threaded shaft on the body for rotation with respect to the same to cause movement of the clamping portion towards or away from the said locating portion.

5. Apparatus according to claim 4 wherein, when located with the base, the longitudinal axis of the threaded shaft and the direction of movement of the clamping portion when the actuation means is operated, are substantially perpendicular to the surface of the base on which the workpiece is positioned.

6. Apparatus according to claim 1 wherein the locating portion is provided to be selectively positioned so as to provide a locating effect on the surface of the base opposing that surface on which the workpiece is to be located.

7. Apparatus according to claim 6 wherein the locating portion is offset with respect to a longitudinal axis of a threaded shaft of the clamping apparatus and to the engaging portion of the body.

8. Apparatus according to claim 7 wherein when the engaging portion locates with a port in the base, part of the locating portion engages with a surface of the base to at least one side of the said port.

9. Apparatus according to claim 8 wherein the locating portion is moveable through a port in the base and, once on the underside of the base, is moved laterally to allow the engaging portion to be engaged in the port with the locating portion extending to contacting the underside of the base to at least one side of the port.

10. Apparatus according to claim 1 wherein the locating portion is provided with a formation to be received in or on a track which is located in or on the base, said track linear in form and the locating portion and engaging portion selectively located along the track.

11. Apparatus according to claim 10 wherein the engaging portion includes one or more lugs which protrude laterally from the locating portion to engage with channels in the track.

12. Apparatus according to claim 7 wherein the base is provided with a plurality of said ports in a spaced configuration.

13. A clamping assembly, said assembly including clamping apparatus provided to exert a clamping effect on a workpiece with respect to a base, said clamping apparatus including an elongate shaft, at least one locating portion and an engagement portion provided at, or towards, one end of the said shaft, a user operated actuation means selectively located between the said locating portion and the opposing end of the elongate shaft, said actuation means provided with or connected to a clamping portion and wherein said base is provided with multiple ports or tracks with which the said locating portion and engagement means are selectively located by a user so as to selectively position the clamp apparatus with respect to the base.

14. An assembly according to claim 13 wherein the multiple ports or tracks are provided in a spaced configuration across the surface of the base on which the workpiece is to be clamped, said ports passing between said surface onto which the workpiece is clamped and the opposing surface of the base.

15. Apparatus according to claim 10 wherein the base is provided with a plurality of said tracks in a spaced configuration.
